(19) United States
(12) Patent Application Publication
(10) Pub. No.: US 2004/0009789 A1
(43) Pub. Date: Jan. 15, 2004

(54) Mobile phone

(75) Inventors: Chang Jin Park, Yongin-Shi (KR); In Soon Yu, Seoul (KR)

Correspondence Address: LADAS & PARRY, 26 WEST 61ST STREET, NEW YORK, NY, 10023, US

(73) Assignee: SAMSUNG ELECTRO-MECHANICS CO., LTD.

(21) Appl. No.: 10/423,625

(22) Filed: Apr. 25, 2003

(30) Foreign Application Priority Data
Jul. 9, 2002 (KR) P2002-39561
Jan. 30, 2003 (KR) P2003-06115

(51) Int. Cl. H04M 1/00

(52) U.S. Cl. 455/556.1; 455/557

(57) ABSTRACT

The present invention relates to a mobile phone, comprising: a camera module including a camera for taking pictures and an interface unit; a main body having a processor for driving the camera module; and a battery that is detachably connected to one side of the main body. Using the battery mounted with the camera module, users are now able to use the camera any time regardless of the folder being opened or not. The mobile phone of the present invention lightens economical burden of both the users and the mobile phone producers in that the users can selectively purchase the camera only and the mobile phone producers can continue to produce a single model mobile phone with no obligation of attaching the camera to the mobile phone.

### BACKGROUND OF THE INVENTION

1. Field of the Invention

The present invention generally relates to a mobile phone, and more particularly, to a mobile phone with a built-in camera with a functionality of transmitting images wirelessly.

2. Description of the Related Art

The use of wireless communication devices is now commonplace. In particular, mobile phones were always going to be part of the most rapidly and widely provided communication device.

To meet diverse needs of users, much development work has been invested in adding functionalities, such as receiving wireless emails and transmitting images, to mobile phones.

Usually a separate camera is needed to send images. The camera can be either clipped on the mobile phone in the form of accessories (i.e. external camera) or built in the main body of the mobile phone (i.e. internal or on-board camera).

The former is provided in the form of detachably connectable accessories so users can clip the camera on the mobile phone whenever necessary. This uglified the appearance of the mobile phone and sometimes mobile phone users lost the camera.

To obviate the above, introduced was a mobile phone with a built-in camera as shown in FIGS. 1 and 2.

More specifically, FIG. 1 illustrates a mobile phone with a built-in camera (so called “camera phone”) comprising a main body 10, a folder 20 for selectively protecting inside of the main body 10, and a camera 30 which is built in a low part of the folder 20.

FIG. 2 illustrates another conventional mobile phone with a built-in camera, in which the camera 3 is disposed between a main body 1 and a folder 2, being exposed when the folder 2 is opened.

One of drawbacks found in the camera phone of FIG. 1 was that the built-in camera 30 on the folder 20 becomes useless when the folder 20 is opened.

Although the camera phone of FIG. 2 could be an answer for solving the above problem in that mobile phone users can take pictures with the camera while the folder 2 is being opened, this was exposed to another problem. That is, users had to open the folder 2 first to the camera.

Moreover, the camera phones illustrated in FIGS. 1 and 2 are very expensive as a mobile phone is combined with the camera 3 and 30. Hence many mobile phone users had no choice but purchasing the camera phone at high cost even though they did not need the camera 3 and 30 at all.

Of course, users do not have to buy camera phones but buy mobile phones without camera instead if they wanted to save money even if this could mean that they would have to experience the inconvenience of not being able to use the camera 3 and 30 when it is necessary. Then when it comes to a point that they need the camera 3 and 30, they have to buy another brand-new mobile phone with a built-in camera 3 and 30.

On the other hand, mobile phone producers had to continue to produce mobile phones with and without camera 3 and 30 to meet the request of consumers. This kind of production was carried out independent of developing new mobile phones. As a result, manufacturing cost the mobile phone producers had to pay doubled.

In addition, to produce two types of mobile phones, companies had to make two separate production lines, spending so much money on making the production lines.

### SUMMARY OF THE INVENTION

It is, therefore, an object of the present invention to provide a mobile phone that users can decide whether or not to use a camera with or without a folder being opened while lightening their economical burden on the purchase of the mobile phone.

To achieve the above object, there is provided a mobile phone including a camera module; a main body having a processor for driving the camera module; and a battery mounted with the camera module, being detachably connectable to one side of the main body.

Preferably, the camera module includes a camera for taking photographs; and an interface unit for interfacing with the processor of the main body so as to operate the camera.

### BRIEF DESCRIPTION OF THE DRAWINGS

The above objects, features and advantages of the present invention will become more apparent from the following detailed description when taken in conjunction with the accompanying drawings, in which:

FIGS. 1 and 2 are front views of a camera phone in a related art;

FIG. 3 is a rear view of a mobile phone according to a first preferred embodiment of the present invention;

FIG. 4 is a front and rear view of a battery illustrated in FIG. 3;

FIG. 5 is a side view of the mobile phone illustrated in FIG. 3;

FIG. 6 is a front and rear view of a battery without a camera module;

FIG. 7 is a front and rear view of a battery with a camera module according to a second preferred embodiment of the present invention;

FIG. 8 is a front and rear view of a battery with a camera module according to a third preferred embodiment of the present invention; and

FIG. 9 is a front and rear view of a battery with a camera module according to a fourth preferred embodiment of the present invention.

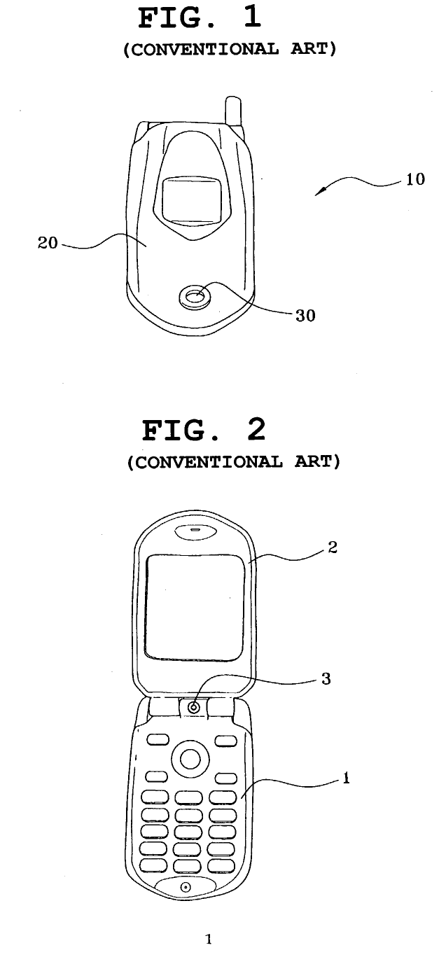

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

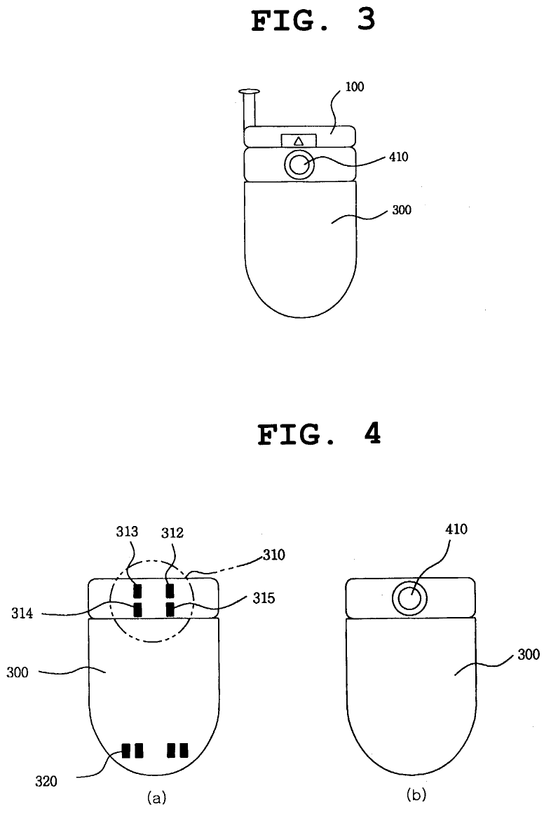

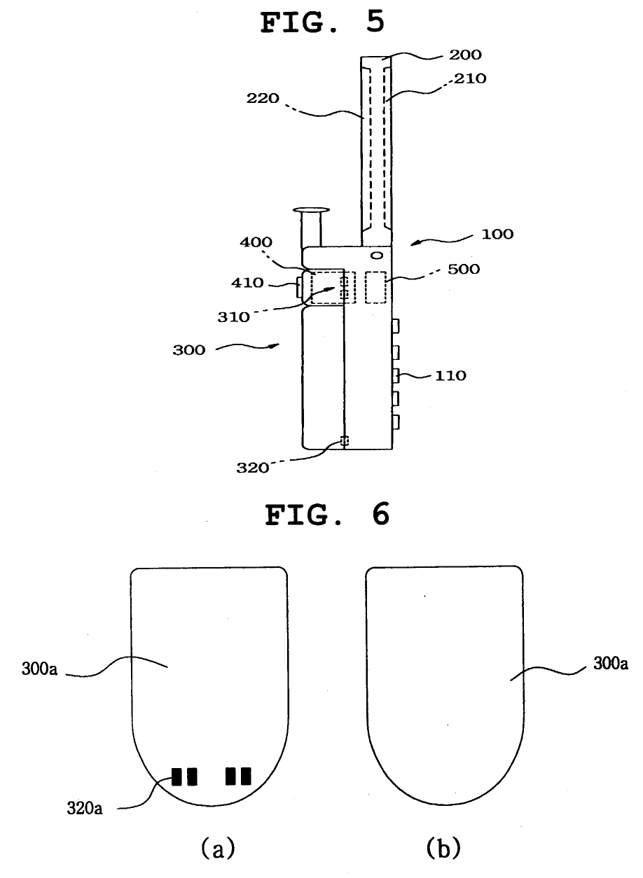

FIG. 3 is a rear view of a mobile phone, more particularly, a mobile phone mounted with a battery, according to a first preferred embodiment of the present invention. FIG. 4 is a front and rear view of the battery depicted in FIG. 3, (a) illustrating the rear view of the battery and (b) illustrating the front view of the battery.

FIG. 5 is a side view of the mobile phone of FIG. 3. Particularly, FIG. 5 shows a folder 200 connected to a main body 100 of the mobile phone is being opened.

As shown in the drawing, the mobile phone of the present invention includes the main body 100, the folder 200 connected to the main body 100, and the battery 300 with a camera 410 that is detachably connectable to the main body 100.

In particular, the main body is composed of a communication unit (not shown) and a plurality of function keys 110. The main body 100 is set in a manner that the folder 200 for protecting inside of the main body 100 of the mobile phone, it having an inside display window 210 on its rear surface and an outside display window 220 on its front surface, is detachably connected to the main body 100.

Also, the battery 300, a power source, is detachably connected to the rear surface area of the main body 100. Combined with the battery 300 is a camera module 400 for taking photographs and a power terminal 320 on the lower part of the battery for supplying power to the main body 100.

The camera module 400 consists of the camera 410 connected to the opposite side of the main body 100 for taking pictures and a connection terminal 310 formed on the rear side of the camera 410 for interfacing the camera 410 with the main body 100 and applying power from the battery 300 to the camera 410.

Of course, the main body has a built-in processor 500 for controlling the camera module 400 and receiving optical data inputted from the connection terminal 310 of the battery 300.

Meanwhile, the connection terminal 310 of the camera module 400 has four pins that make USB and UART interface possible. As depicted in FIG. 4, the four pins consist of a data input terminal 312 and data output terminal 313 for transceiving data with the main body 100, a power terminal 314 for getting power from the battery 300, and a ground terminal 315.

To operate the mobile phone illustrated in FIGS. 3 through 5, users first need to mount the battery 300 on the main body 100 for power supply and operate the function keys 110 to drive the processor 500 and the camera module 400 and take pictures they want. The photographed images are later displayed on the display.

To be more specific, when the user operates the function keys 100, particularly a function key that is designated as power on/off switch for the camera 410, of the main body 100, the processor 500 flows applied voltage from the battery 300 to the main body 100 in the power terminal 314 and the ground terminal 315 of the connection terminal 310, thereby supplying power to the camera module 400.

Moreover, when the user operates a function key 110 that is designated to control the operation of the camera 410, the processor 500 applies a drive signal to the camera module 400 through the connection terminal 310, namely the data input terminal 312, allowing the user to take pictures with the camera 410.

The photographed images are transmitted to the main body 100 through the data output terminal 313, and the transmitted images are displayed on either the inside display window 210 or the outside display window 220 of the folder connected to the main body 100.

When the user photographs a subject while looking at the inside display window 210 on the opposite side of the camera 410, the image will show on the inside display window 210. Also, when the user takes a picture of him by looking at the camera 410, his picture will show on the outside display window 220.

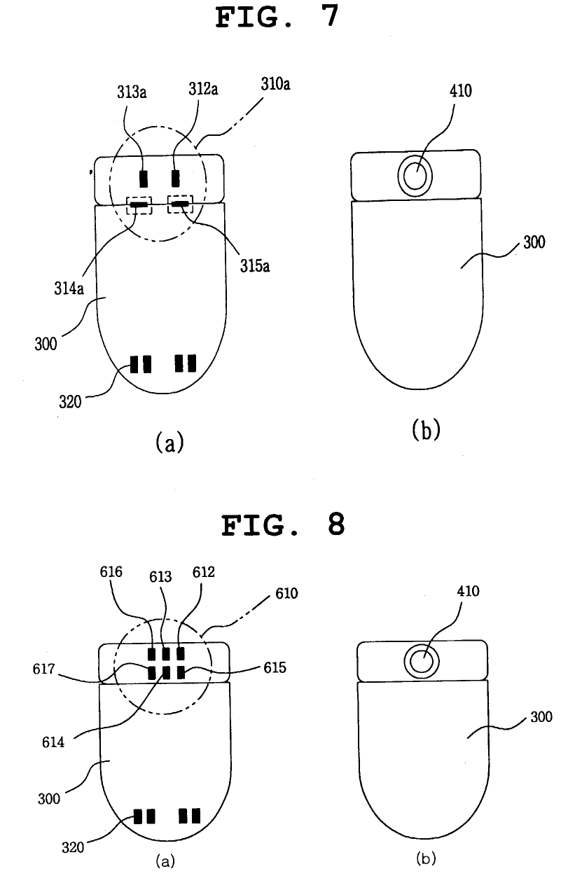

On the other hand, if the user does not need the camera 410, he can just use a battery 300′ shown in FIG. 6 that has a power terminal 320′ and not the camera 410. Thanks to the development of this kind of battery 300′, the user is now able to choose the battery 300 with the camera 410 or the battery 300′ without the camera 410 at will.

FIG. 6 illustrates the front and rear views of the battery without the camera module. FIG. 6(a) is the rear view of the batter and FIG. 6(b) is the front view of the battery.

On the contrary, FIG. 7 illustrates the front and rear views of the battery with the camera module. FIG. 7(a) is the rear view of the batter and FIG. 7(b) is the front view of the battery.

This battery has basically the same construction and function as the battery of the first embodiment. The only difference between them is, although the camera module 400 of the first embodiment is provided with power from the battery 300 via the main body 100, the power terminal 314′ and the ground terminal 315′ of the connection terminal 310′ are built in the battery 300 according to the second embodiment in order to supply power directly to the camera module 400.

Therefore, for the battery 300 according to the second embodiment, the same reference numerals used in the battery according to the first embodiment were used again and no further explanation will be provided.

One thing different about the battery of FIG. 7 is that the data input/output terminals 312′ and 313′ are formed on the rear surface of the battery 300 for the user to be able to see while the power terminal 314′ and the ground terminal 315′ are concealed inside of the battery 300.

When there is no drive signal for the camera module 400 is inputted from the processor 500 for a certain period of time after the above battery is mounted on the main body 100, the power terminal 314′ automatically shuts off the power, thereby preventing discharge of the battery 300.

Of course, the power terminal 314′ is automatically shut off when the battery is taken out of the main body 100. Either way, the battery is safe from discharge.

Once the battery is set on the main body 100, the user can take pictures by operating the processor 500 and the camera 410. The photographed optical images are then interfaced with the main body 100 by the data input/output terminals 312′ and 313′ and displayed.

FIG. 8 illustrates the front and rear views of the battery with the camera module according to the third embodiment of the present invention. FIG. 8(a) is the rear view of the batter and FIG. 8(b) is the front view of the battery.

Unlike the batteries with 4-pinned connection terminals 310 and 310′ in the first and second embodiments, the battery of FIG. 8 has 6-pinned connection terminal 610 for SPI interface.

As shown in the drawing, the connection terminal 610 according to the third embodiment further includes a CS terminal 616 and a CLK terminal 617 in addition to the data input/output terminals 612 and 613, the power terminal 614 and the ground terminal 615.

Similar to the first embodiment, the camera module 400 is powered when the battery 300 supplies power to the power terminal 614 and the ground terminal 615 via the main body 100. Also, taking pictures with the camera 410 and displaying photographed images are performed with help of the data input/output terminals 612 and 613, the CS terminal 616, and the CLK terminal 617 that interface with the processor 500 of the main body 100.

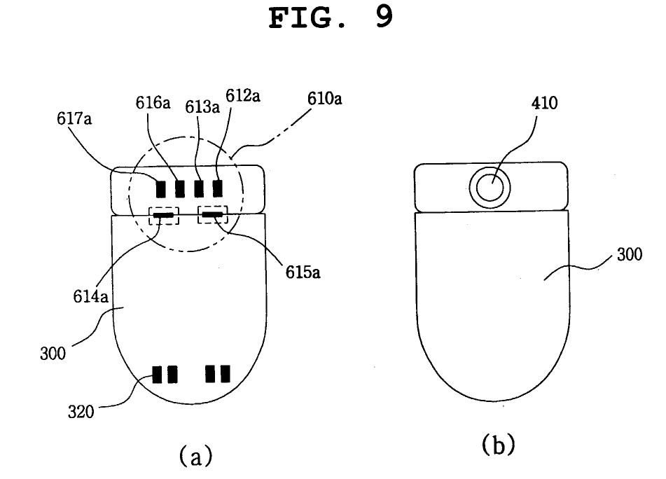

FIG. 9 illustrates the front and rear views of the battery with the camera module according to the fourth embodiment of the present invention. FIG. 9(a) is the rear view of the batter and FIG. 9(b) is the front view of the battery.

The battery of FIG. 9 basically has the same construction and function with the one according to the third embodiment except that the power terminal 614′ and the ground terminal 615′ are built in the battery 300 as in the second embodiment.

That is, the data input/output terminals 612′ and 613′, the CS terminal 616′, and the CLK terminal 617′ of the connection terminal 610′ of the camera module mounted on the battery 300 are formed on the rear surface of the battery 300 for the user to be able to see while the power terminal 614′ and the ground terminal 615′ are concealed inside of the battery 300.

Similar to the second embodiment, the camera module 400 is powered directly by the battery 300 through the power terminal 614′ and the ground terminal 615′ without passing through the main body 100. Also, taking pictures with the camera 410 and displaying photographed images are performed with help of the data input/output terminals 612′ and 613′, the CS terminal 616′, and the CLK terminal 617′ that interface with the processor 500 of the main body 100.

Again, to prevent the battery discharge, the camera module is designed in a manner that the power terminal 614′ thereof is automatically shut off in case that there is no drive signal for the camera module is inputted from the processor 500 of the main body 100 for a certain period of time or the battery 300 is separated from the main body 100 for a certain period of time.

As described above, the mobile phones according to the first through fourth embodiments of the present invention allow the mobile phone users to use the camera 410 whether the folder 200 is opened or not. Moreover, the users now get to choose either the battery 300 with the camera 410 or the battery 300′ without the camera 410.

Now that the camera is detachably connectable to the battery, the user can select the battery 300 with the camera 410 or the battery 300′ without the camera 410 at his will. In other words, the user does not have to spend much money purchasing another main body 100 with a built-in camera 410 just because he needs to use the camera, and the mobile phone producers can continue to produce a single model main body regardless of the camera 410, saving a great deal of the manufacturing cost.

In conclusion, the present invention provides the battery mounted with the camera, which allows the mobile phone users to use the camera any time with the folder being opened as well as closed.

Moreover, since the users have an option to choose either the battery with the camera or the battery without the camera, their economical burden is much lightened and they can use either type of the battery at will.

In addition, now that the camera is not attached to the main body, the mobile phone producers can continue to produce a single model main body and save a great deal of money for developing mobile phones and adding additional production lines.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A mobile phone comprising:
a camera module;
a main body having a processor for driving the camera module; and
a battery mounted with the camera module, the battery being detachably connectable to one side of the main body.

2. The mobile phone according to claim 1, wherein the main body and the camera module are connected through 4 pins including a power terminal, a ground terminal, a data input terminal and a data output terminal.

3. The mobile phone according to claim 1, wherein the main body and the camera module are connected through 2 pins including a data input end and a data output end; and the battery and the camera module are connected through 2 pins including a power terminal and a ground terminal.

4. The mobile phone according to claim 1, wherein the main body and the camera module are connected through 6 pins including a power terminal, a ground terminal, a data input terminal, a data output terminal, a CS terminal, and a CLK terminal.

5. The mobile phone according to claim 1, wherein the main body and the camera module are connected through 4 pins including a data input terminal, a data output terminal, a CS terminal, and a CLK terminal; and the battery and the camera module are connected through 2 pins including a power terminal and a ground terminal.

6. The mobile phone according to claim 1, wherein the camera module comprises:
a camera for taking pictures; and
an interface unit for interfacing with processor of the main body so as to operate the camera.

7. The mobile phone according to claim 6, wherein the interface unit is a USB interface.

8. The mobile phone according to claim 6, wherein the interface unit is a UART interface.

9. The mobile phone according to claim 6, wherein the interface unit is a SPI interface.
